(19) United States
(12) Patent Application Publication
(10) Pub. No.: US 2008/0237113 A1
(43) Pub. Date: Oct. 2, 2008

(54) SPIN-ON FILTER CARTRIDGE

(76) Inventor: Russell D. Jensen, Modesto, CA (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/055,690

(22) Filed: Mar. 26, 2008

Related U.S. Application Data
(60) Provisional application No. 60/908,056, filed on Mar. 26, 2007.

(51) Int. Cl. B01D 29/00; B01D 27/08

(52) U.S. Cl. 210/232; 210/236; 210/542; 210/443

(57) ABSTRACT

A spin-on filter cartridge (20) comprising a cannister (21), a filter element (22), and an adaptor-mounting plate (24) positioned within the cannister (21) between its open end and the filter element (22). The adaptor-mounting plate (24) has a scooped-ramped inner perimeter that allows non-threaded engagement with an adaptor (60). To install the filter cartridge (20) onto a threaded mounting stud (61), the cartridge (20) is rotated (e.g., “spun”) relative to the stud (61).

### RELATED APPLICATION

This application claims priority under 35 U.S.C. §119 (e) to U.S. Provisional Patent Application No. 60/908,056, filed on Mar. 26, 2007. The entire disclosure of this provisional application is hereby incorporated by reference.

### FIELD

A filter cartridge constructed for spin-on installation onto a threaded mounting stud.

### BACKGROUND

A filter can be a sometimes small, but usually crucial, item in a fluid system. In a fuel-delivery system, for example, this item filters the fuel upstream of the engine to avoid the ill effects of water and/or contamination. An often preferred filter construction incorporates a “spin-on” filter cartridge that can be easily installed in tight spaces (e.g., a crowded engine compartment). With spin-on installation, connections are made, and seals are formed, by the simple act of spinning the filter cartridge onto a threaded mounting stud.

### SUMMARY

A filter cartridge is provided that allows spin-on installation without the use of threaded cartridge components. The cartridge comprises a cannister, a filter element, and adaptor-mounting plate that allows non-threaded engagement during spin-on installation. In this manner, the cartridge can have a simple construction that is inexpensive to manufacture.

### DRAWINGS

FIGS. 1A-1B (1^{st} drawing set) are top and sectional views of a filter 10 comprising a filter cartridge 20, and an adaptor 60.

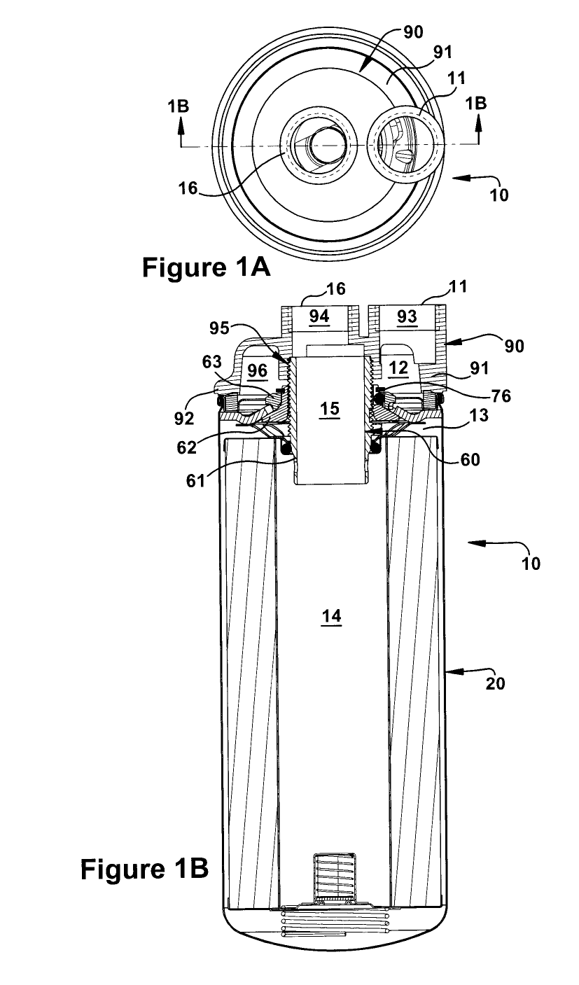

FIGS. 2A-2B (2^{nd} drawing set) are perspective, top, and sectional views of the filter cartridge 20.

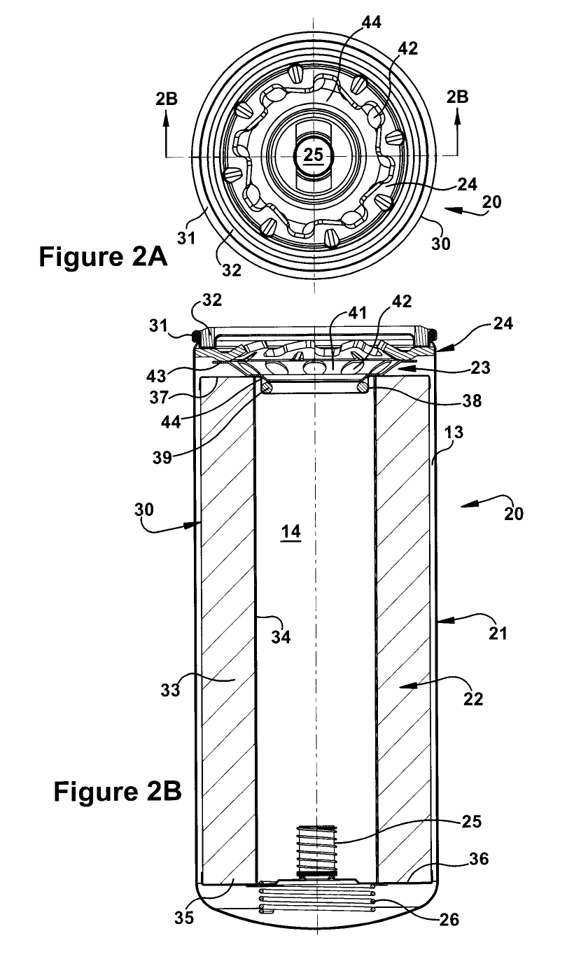

FIGS. 3A-3D (3^{rd} drawing set) are perspective, top, and sectional views of the cartridge's adaptor-mounting plate 24.

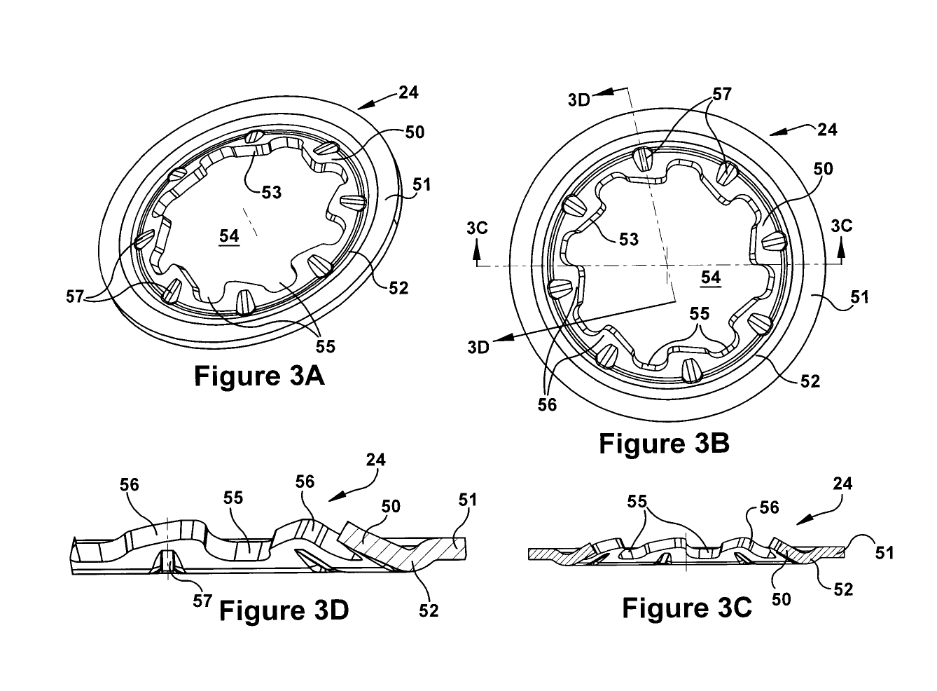

FIGS. 4A-4E (4^{th} drawing set) are perspective, side, sectional, rear, and close-up views of the adaptor's mounting stud 61.

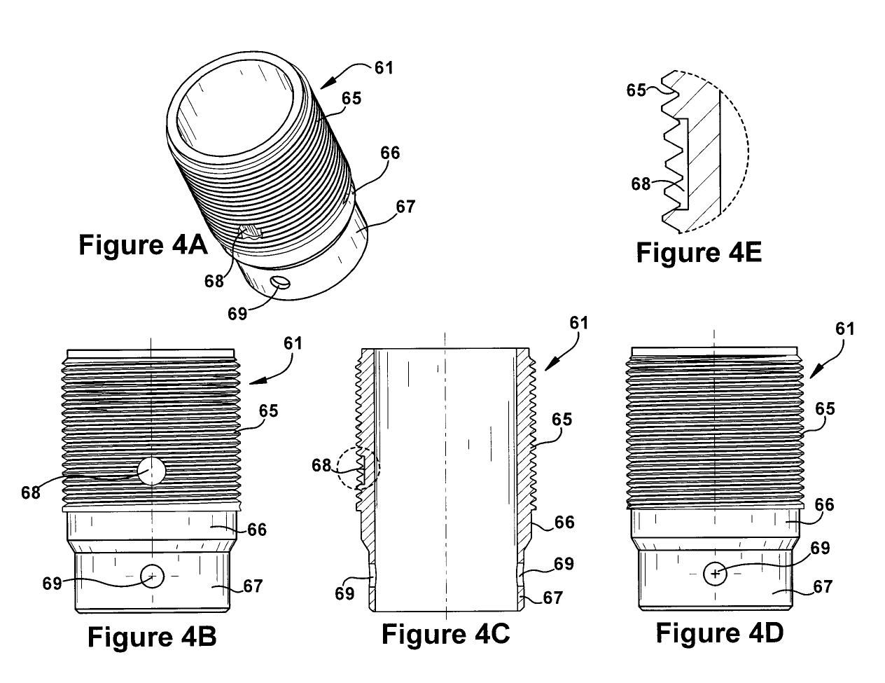

FIGS. 5A-5E (5^{th} drawing set) are perspective, top, side, sectional, and close-up views of the adaptor's carrier 62.

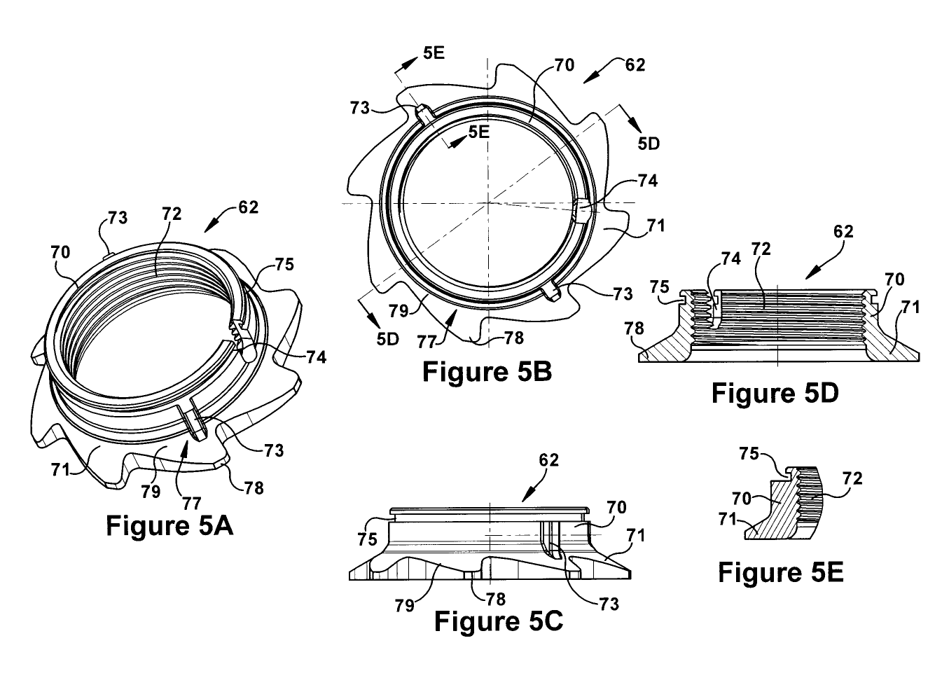

FIGS. 6A-6E (6^{th} drawing set) are perspective, top, bottom, sectional, and close-up views of the adaptor's latcher 63.

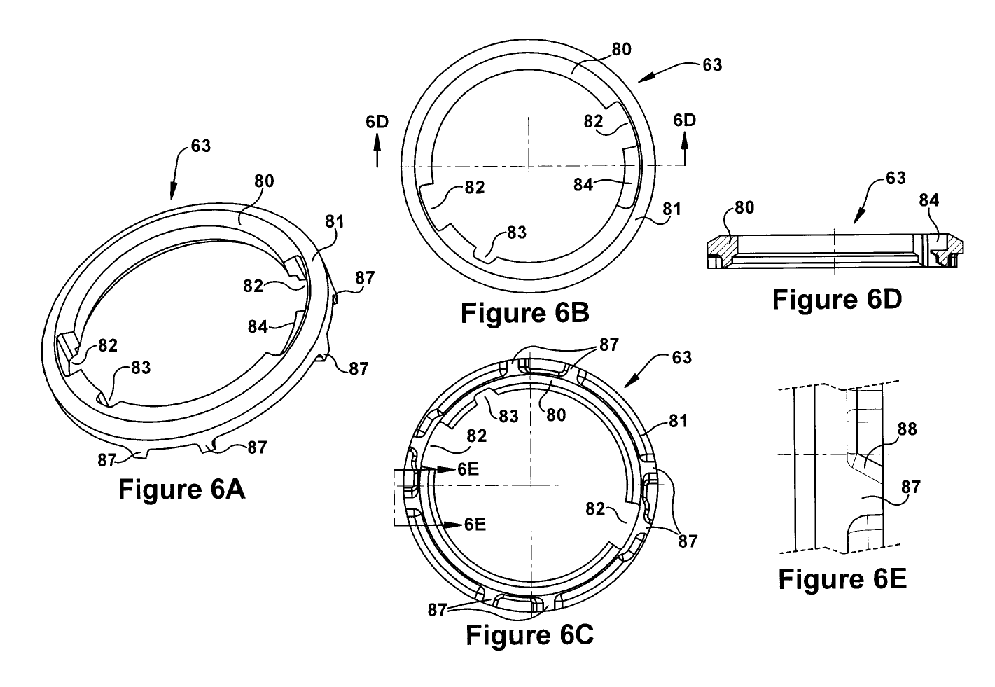

FIGS. 7A-7B (7^{th} drawing set) are side and sectional views of the filter cartridge 20 and the adaptor 60, the adaptor 60 being shown in a stud-carrier-unlatched condition.

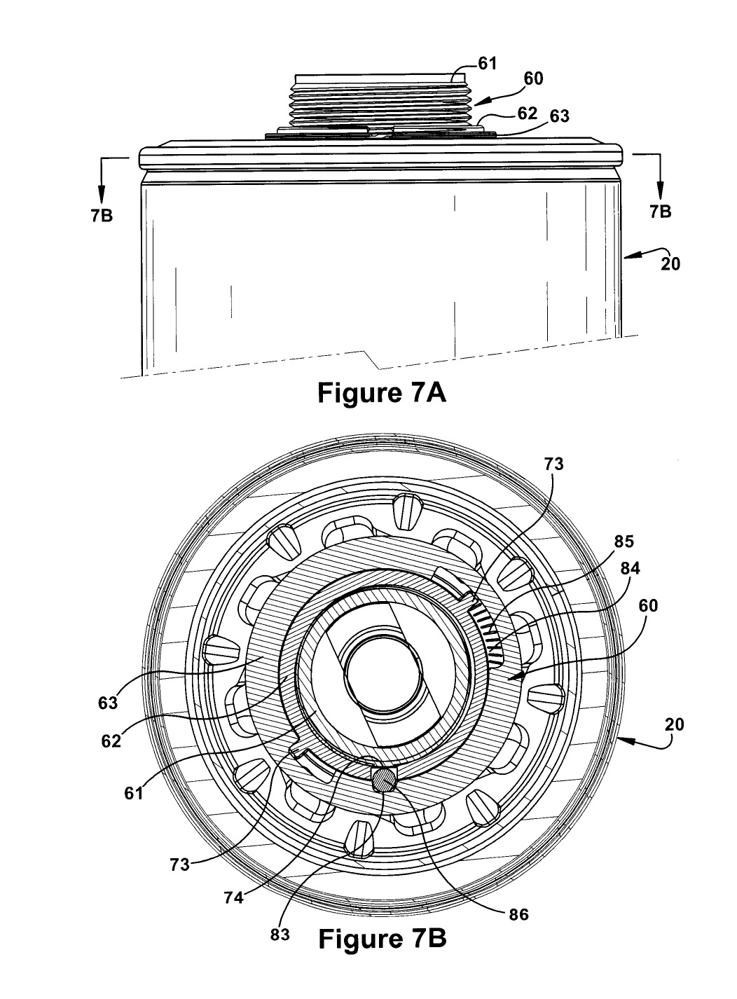

FIGS. 8A-8B (8^{th} drawing set) are side and sectional views of the filter cartridge 20 and the adaptor 60, the adaptor 60 being shown in a stud-carrier-latched condition.

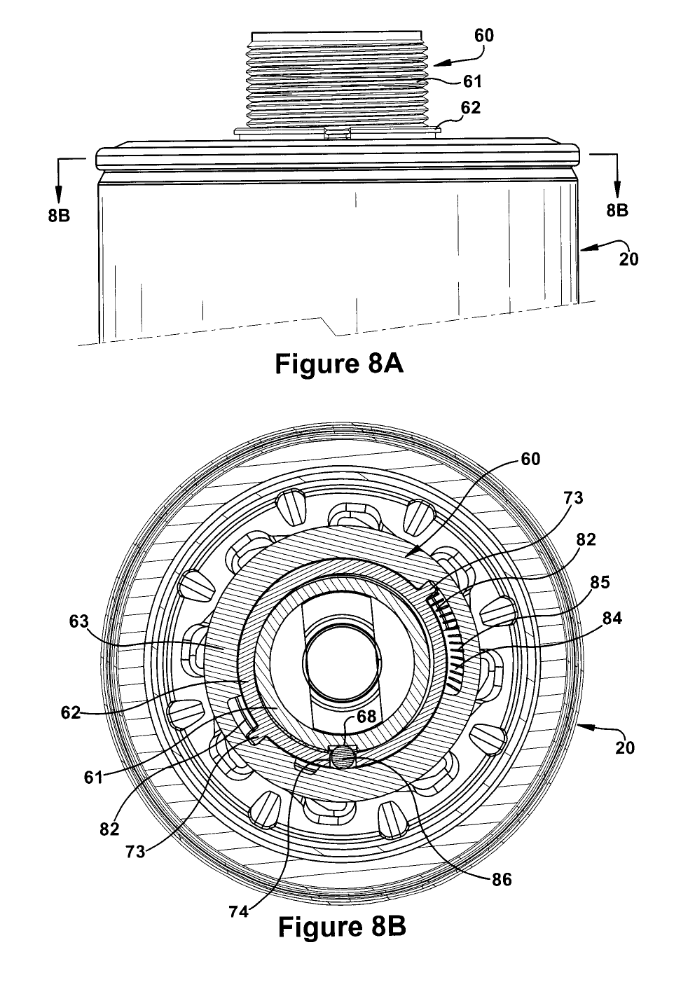

### DESCRIPTION

Referring now to the drawings, and initially to the 1^{st} drawing set, a filter 10 is shown. In operation, the to-be-filtered fluid enters the filter 10 through an inlet port 11. The fluid then travels through inlet chambers 12 and 13 to the filtering media (i.e., filter media 33, introduced below) whereat it is filtered. The filtered fluid travels through outlet chambers 14 and 15, and exits the filter 10 through an outlet port 16.

### Filter Cartridge 20

The filter 10 comprises a filter cartridge 20 (2^{nd} drawing set). The filter cartridge 20 comprises a cannister 21, a filter element 22, a filter cap 23, an adaptor-mounting plate 24, and loading springs 25 and 26.

The cannister 21 comprises a cylindrical shell 30 with an open end and an opposite closed end. The shell 30 an be constructed, for example, of drawn metal (e.g., steel) and/or it can be formed in one-piece. A rim 31 surrounds the cannister's open end and it is shaped to receive a seal 32 (e.g., an elastomeric seal). In the assembled filter 10, the seal 32 seals the interface between the cannister 21 and another component of the filter 10 (namely an adaptor hood 64, introduced below). In smaller sized filters, for example, the cannister's diameter can be in the range of about 10 cm to about 15 cm, and its length can be in the range of about 20 cm to about 40 cm.

The filter element 22 comprises a filter media 33 which can be a cylindrical compilation of longitudinal pleats. The inlet chamber 13 is located outside the pleats' radially outer peaks and the outlet chamber 14 is located inside the pleats' radially inner peaks. The pleat count can be, for example, between about 60 and 80 (e.g., approximately 70), and the filter efficiency can be at least 80% (e.g. 90%) for 20 micron and larger.

The filter element 22 can (but need not) include a center tube 34. The floor 35 of the filter element 22 seals the annular face of the filter media 33 and closes this end of the inner chamber 14. The floor 35 can also include a platform 36 for the loading spring 26 and/or the loading spring 27. The ceiling 37 of the filter element 22 seals the corresponding annular face of the filter media 33, and forms a gutter 38 extending into the inner chamber 14. The gutter 38 holds a seal 39 (e.g., an elastomeric seal).

The illustrated filter cap 23 comprises a canopy portion 41 (with windows 42), a ledge portion 43 and a flange portion 44. These portion 41, 43, 44 surround an open central area. The canopy portion 41 flares outward towards the cannister's open end. The windows 42 form flow passageways from inside the cap 23 (the central open central area) to outside the cap 23 (the inlet chamber 13).

The cap's ledge portion 43 extends radially outward from the upper edge of the canopy portion 41. The capture-flange portion 42 extends radially inward from the canopy's lower edge. The portion 43 forms a ledge for a portion of the adaptor-mounting plate 24 (namely an elbow portion 52 introduced below) and the flange portion 42 captures the seal 39 within the gutter 38.

The adaptor-mounting plate 24 (3^{rd} drawing set) comprises a skirt portion 50 that slopes toward the cannister's open end. A brim portion 51 forms the plate's outer periphery and an elbow portion 52 connects the skirt portion 50 and the brim portion 51. In the assembled cartridge 20, the brim portion 51 seats against the cannister's rim 31 and the elbow portion 52 rests upon the cap's ledge portion 43.

The inner perimeter 53 of the skirt portion 50 forms a central opening 54. The perimeter 53 follows a non-circular path comprising scoop sections 55 and ramp sections 56 bridging adjacent scoop sections. The mounting plate 24 can include at least four scoop-ramp sections 55-56, at least six scoop-ramp sections 55-56, and/or at least eight scoop-ramp sections 55-56. The illustrated plate 24 comprises eight scoop-ramp sections 55-56, with the ramp sections 56 sloping in the clockwise direction. Some or all of the ramp sections 56 can be provided with stiffening ribs 57.

The loading springs 25 and 26 (2^{nd} drawing set) bias the filter element 22 upward. This biasing seats the gutter-held seal 39 against the cap's seal-pressing portion 44, holds the cap's ledge portion 43 against the elbow portion 52 of the adaptor-mounting plate 24, and pushes the plate's brim portion 51 against the cannister's gutter 38.

### Adaptor 60

The filter 10 also comprises an adaptor 60 (1^{st}, 3^{rd}, 4^{th}, 5^{th}, and 6^{th} drawing sets). The adaptor 60 comprises a mounting stud 61, a carrier 62, a latcher 63, and a hood 64. The mounting stud 61 is the stud onto which the filter cartridge 20 is “spun” for installation. The carrier 62 attaches to the filter cartridge 20 and “carries” it during this spinning.

The latcher 63 allows the adaptor 60 to convert between a stud-carrier-unlatched condition (1^{st} and 7^{th} drawing sets) and a stud-carrier-latched condition (8^{th} drawing set). In the unlatched condition, the carrier 62 rotates with the latcher 63 and the being-spun filter cartridge 20. In the latched condition, the carrier 62 remains stationary with the mounting stud 61 and the latcher 63 can rotate relative to the carrier 62.

The mounting stud 61 (4^{th} drawing set) comprises portions 65, 66, and 67, which together form a passageway from the chamber 14 to the chamber 15. The portion 65 has external threads which mate with internal threads on the carrier 62. The portion 66 provides a seat for the seal 39 carried by the cannister gutter 38 and captured by the cap portion 42. And the portion 67 forms the stud's insertion head when mounting the adaptor 60 to the cartridge 20. The thread portion 65 has a pocket 68 and the neck portion 67 can be provided with holes 69.

The carrier 62 (5^{th} drawing set) comprises a stem portion 70 and a skirt portion 71. The stem portion 70 has internal threads 72, radially projecting tabs 73, and a slot 74. The tabs 73 are spaced 1800 apart and the slot 74 is spaced from the closest tab about 350 in the counterclockwise direction. A retainer groove 75 is situated near the distal end of the stem portion 70, and retainer 76 is positioned therein (1^{st} drawing set).

The carrier's skirt portion 71 includes a plurality of blade-like elements 77 that project from the stem portion 70 in a pinwheel manner. The illustrated elements 77 each have a shark-fin shape with a flattened tip section 78 and a ramp section 79 leading thereto. The ramp sections 79 each incline in the counterclockwise direction towards its corresponding tip section 78. The ramp thickness decreases in the counterclockwise direction towards the connected tip section 78. And the opposite side of each tip section 78 increases in thickness towards the succeeding ramp section 79.

The latcher 63 (6^{th} drawing set) has an inner ring portion 80 and an outer border portion 81. The ring portion 80 has an annular shape with flat axial faces. Slots 82, a pocket 83, and a ledge 84 are formed in the ring portion 80. The slots 82 and the pocket 83 extend completely through the ring thickness, the ledge 84 extends only partially therethrough. The slots 82 and the ledge 84 extend entirely through the ring width, the pocket 83 does not. The slots 82 are radially spaced about 180° apart and the ledge 84 is radially coextensive (in the clockwise direction) with one of the slots 82. The pocket 83 is radially spaced from the ledgeless slot 82 (from its clockwise edge) about 15° to about 40° in the counterclockwise direction. A spring 85 is situated in the ledge 84 and biases the adaptor 60 its stud-carrier-latched condition (8^{th} drawing set). When the adaptor 60 is in its stud-carrier-unlatched condition, a ball 86 is situated in the pocket 83 (7^{th} drawing set).

The latcher's border portion 81 has a tapered upper face and a flat lower face, with stub-like legs 87 projecting downward from the lower face. The legs 87 are grouped in pairs, with four pairs of legs 87 being equally spaced around the border's circumference. The spacing between the two legs 87 in each pair corresponds to an intermediate width of the ramp sections 53 in the adaptor-mounting plate 24. The non-facing sides 88 of the grouped-in-pair legs 87 (i.e., the outer faces of each leg pair) are inclined downward.

In the assembled adaptor 60 (1^{st}, 7^{th} and 8^{th} drawing sets), the mounting stud 61 is positioned within the carrier 62 and the latcher 63 is positioned around the carrier 62. The carrier's stem portion 70 is screwed onto the stud's thread portion 65. The latcher 63 is slipped around the carrier's stem portion 70 and the retainer 76 holds the parts together. The carrier tabs 73 are situated for sliding movement in the latcher slots 82.

When the adaptor 60 is in its stud-carrier-unlatched condition (7^{th} drawing set), the ball 86 is trapped in the compartment formed by the carrier pocket 74 and the latcher pocket 83. The carrier tabs 73 are abutted against the clockwise side of the latcher slots 82 and the spring 85 is compressed onto the latcher ledge 84. In this condition, the mounting stud 61 can rotate relative to the carrier 62.

When the adaptor 60 is in its stud-carrier-latched condition (8^{th} drawing set), the locking ball 86 is trapped in the compartment formed by the stud pocket 68 and the carrier pocket 74. The carrier tabs 73 are abutted against the counterclockwise side of the latcher slots 82 and the spring 85 extends across the latcher ledge 84 and the adjacent latcher slot 82. In this condition, the carrier 62 remains stationary with the mounting stud 61 and the latcher 63 can rotate relative to the carrier 62.

The port-providing hood 64 (1^{st} drawing set) can include a dome-like wall 91 with a rim 92, an inlet passage 93, an outlet passage 94, and a stud-connecting passage 95. The open ends of the passages 93 and 94 form the inlet and outlet ports 11 and 16, respectively. These port-forming ends of the passages 93 and 94 can be threaded or otherwise constructed for connection to inlet/outlet fluid lines in the overall fluid system (e.g., a fuel-delivery system).

The inlet passage 93 leads from the inlet port 11 to an annular space 96 surrounding the passage 95. The passage 93 and this space 96 form the inlet chamber 12. The passage 95 leads into the outlet passage 94 which forms, and leads to, the outlet port 16. The hood's passages 94 and 95, along with the hollow interior of the mounting stud 61, form the outlet chamber 15.

The passage 95 has internal threads that mate with external threads on the stud portion 65. In the assembled filter 10, the hood's rim 92 seats against the cannister-rim seal 32, thereby preventing fluid leakage from the inlet chamber 12 at the cannister-hood interface.

### Cartridge-Adaptor Assembly

In the fluid system, the mounting stud 61 and the hood 64 are stationarily mounted relative to the system and they do not rotate relative to the mounting platform surface (e.g., a wall in the engine compartment) or each other. The carrier 62 and the latcher 63 remain assembled to the mounting stud 61 and or not removed/replaced with the cartridge filter 20.

Prior to assembly of the filter cartridge 20, the adaptor 60 is in its stud-carrier-latched condition (8^{th} drawing set), thanks to the biasing spring 85 in the latcher 63. In the latched condition, the ball 86 is in the compartment formed by the stud pocket 68 and the carrier pocket 74. The carrier 62 rotates relative to the stud 61, and the carrier 62 and the latcher 63 rotate together.

To install the filter cartridge 20 onto the adaptor 60, the stud 61 is inserted into the cannister 21 and into the inner chamber 14. The stud's neck portion 67 can be temporarily aligned with the seal 39 to insure that the cartridge 20 is not tilted relative to the adaptor 60.

The filter cartridge 20 is then rotated (i.e., “spun”) relative to the mounting stud 61. During this rotation, the carrier's skirt portion 71 slips underneath the skirt portion 50 of the adaptor-mounting plate 24. Particularly, the shark-fin-shape elements 77 pass through the plate's inner perimeter 53. More particularly, the tip sections 78 pass through the plate's scoop sections 55 and the ramp sections 56 follow. The upward tilt of the plate's ramp sections 56 and their counterclockwise ramp direction, along with the sloping thickness of the carrier's ramp sections 79 and their clockwise ramp direction, facilitates this insertion.

Rotation of the latcher 63 relative to the carrier 62 results in the ball 86 moving from the carrier-latcher compartment (the compartment formed by the stud pocket 68 and the carrier pocket 74) to the compartment formed by the carrier pocket 74 and the latcher pocket 83. The adaptor 60 is thereby converted to its stud-carrier-unlatched condition, In this condition, the carrier 62 and the latcher 63 can rotate relative to the stud 61.

In the latched condition, the latcher's legs 87 straddle ramp sections 56 of the adaptor-mounting plate 24. Further “spinning” of the filter cartridge 20 results in rotation of the latcher 63, but not the carrier 62. The filter cartridge 20, the carrier 62, and the latcher 63, continue up the thread the stud 61 until the seal 32 is tightly seated (between the cannister rim 31 and the hood rim 92) and the seal 39 is tightly seated (against the gutter 38, the cap flange 44, and the stud portion 66.

In the assembled filter 10, the to-be-filtered fluid enters the inlet port 11, passes into the inlet chamber 12 (formed by the hood passage 93 and the annular space 96), through the scoop sections 55 of the adaptor-mounting plate 24, through the windows 42 of the filter cap 23, and into the inlet chamber 13 (between the cannister 20 and the outer surface of the filter media 33). The fluid then travels radially inward and is filtered by the media 33. The filtered fluid flows from the outlet chamber 14 through the mounting stud 61 into the outlet chamber 15 (formed by the hood passages 94 and 95) and exits through the outlet port 16.

### Closing

One may now appreciate that the filter cartridge 20 can be constructed without a threaded component for adaptor-mounting purposes, and still allow spin-on installation with a threaded mounting stud.

Although the filter 10, the filter cartridge 20, the adaptor-mounting plate 24, the adaptor 60, and/or the hood 64, have been shown and described with respect to a certain embodiment, equivalent alterations and modifications will occur to others skilled in the art upon the reading/understanding of this specification and the annexed drawings. For example, instead of the fluid flowing radially inward, as described, it could instead flow radially outward (in which case the ports 11/16, the chambers 12/15, the chambers 13/14, and the passages 93/94 would switch inlet-outlet assignments).

In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application. If incorporated-by-reference subject matter is inconsistent with subject matter expressly set forth in the written specification (and/or drawings) of the present disclosure, the latter governs to the extent necessary to eliminate indefiniteness and/or clarity-lacking issues. Unless otherwise indicated, direction modifiers (e.g., upward, downward, top, bottom, upper, lower, floor, ceiling, etc.) are used only for ease in explanation, and do not limit components to any particular orientation.

1. A spin-on filter cartridge comprising:
a cannister having an open end;
a filter element positioned within the cannister; and
an adaptor-mounting plate positioned within the cannister between its open end and the filter element;
wherein the adaptor-mounting plate has an inner perimeter defining a non-threaded central opening and following a non-circular path.

2. A spin-on filter cartridge as set forth in claim 1, wherein the adaptor-mounting plate is formed in one piece.

3. A spin-on filter cartridge as set forth in claim 2, wherein the inner perimeter comprises scoop sections and ramp sections bridging adjacent scoop sections.

4. A spin-on filter cartridge as set forth in claim 3, wherein the inner perimeter has eight scoop sections and eight ramp sections.

5. A spin-on filter cartridge as set forth in claim 4, wherein the ramp sections slope in the clockwise direction.

6. A spin-on filter cartridge as set forth in claim 5, wherein the adaptor-mounting plate comprises:
a skirt portion that forms the plate's inner perimeter and flare towards the open end of the cannister;
a brim portion that forms the plate's outer periphery and seats against a rim of the cannister; and
an elbow portion between the skirt portion and the brim portion, that rests on a ledge portion of a filter cap.

7. A spin-on filter cartridge as set forth in claim 5, wherein the cannister comprises a rim surrounding its open end and an elastomeric seal is positioned in the rim.

8. A spin-on filter cartridge as set forth in claim 5, wherein the filter element comprises a filter media that is a cylindrical compilation of longitudinal pleats;
wherein an outer chamber is located outside the pleats' radially outer peaks and inside the cannister and an inner chamber is located inside the pleats' radially inner peaks.

9. A spin-on filter cartridge as set forth in claim 8, wherein the filter element further comprises a center tube positioned inside the filter media.

10. A spin-on filter cartridge as set forth in claim 7, wherein a gutter extends into the inner chamber and a seal is carried by this gutter.

11. A spin-on filter cartridge as set forth in claim 5, further comprising a loading spring that biases the filter element towards the open end of the cannister.

12. A spin-on filter cartridge as set forth in claim 5, further comprising a filter cap having window that form flow passages, and wherein the adaptor-mounting plate is positioned between the cap and the open end of the cannister.

13. A method of installing the spin-on filter cartridge set forth in claim 1, by spinning the filter cartridge onto a threaded mounting stud.

14. A spin-on filter cartridge as set forth in claim 1, wherein:
the cannister comprises a rim surrounding its open end and an elastomeric seal is positioned in the rim.
the filter element comprises a filter media that is a cylindrical compilation of longitudinal pleat, an outer chamber being located outside the pleats' radially outer peaks and inside the cannister and an inner chamber being located inside the pleats' radially inner peaks;
a gutter extends into the inner chamber formed by the filter media, and a seal is carried by this gutter;
the filter element further comprises a center tube positioned inside the filter media;
the filter cartridge further comprises a filter cap having windows that form flow passages;
the adaptor-mounting plate is positioned between the cap and the open end of the cannister; and
the filter element is biased towards the open end of the cannister.

15. A spin-on filter cartridge as set forth in claim 14, wherein the cannister has a diameter in the range of about 10 cm to about 15 cm, and an axial length in the range of about 20 cm to about 40 cm.

16. A spin-on filter cartridge as set forth in claim 14, wherein the cannister has a closed end opposite its open end.

17. A method of installing the spin-on filter cartridge set forth in claim 14, by spinning the filter cartridge onto a threaded mounting stud.

18. A filter comprising the spin-on filter cartridge set forth in claim 1 and an adaptor comprising a mounting stud, a carrier, and a latcher;
wherein the adaptor (60) is convertible to stud-carrier-unlatched condition, whereat a carrier (62) rotates relative to a mounting stud (61), and to a stud-carrier-unlatched condition whereat a carrier (62) remains stationary with the mounting stud.

19. A method of assembling the filter set forth in claim 18, comprising the steps of spinning the fluid cartridge relative to a mounting stud of the adaptor, wherein:
wherein the adaptor in a stud-carrier-latched condition during initial spinning steps and a stud-carrier-unlatched condition during latter spinning steps; and
wherein the mounting stud of the adaptor remains stationary during said spinning steps.
